(19) United States
(12) Patent Application Publication
(10) Pub. No.: US 2012/0312093 A1
(43) Pub. Date: Dec. 13, 2012

(54) SYSTEMS, METHODS, AND VESSELS FOR MEASURABLE CONTENTS

(76) Inventor: Daniel Edward Kokin, San Francisco, CA (US)

(21) Appl. No.: 13/090,851

(22) Filed: Apr. 20, 2011

(51) Int. Cl. G01F 19/00

(52) U.S. Cl. 73/427

(57) ABSTRACT

This application discloses a measuring vessel which avoids the disadvantages of prior measuring vessels while affording additional operating advantages.

A significant aspect is the provision of a vessel which provides graduated bidirectional indicia, with which one volume is adjusted to accommodate a second volume without changing the sum of both volumes.

Another significant aspect is the provision of a method for measuring and manipulating the contents of a vessel. The invention offers certain advantages such as reducing waste and enhancing the precision of manually dispensed fluids.

Another aspect is the provision of a vessel which provides bidirectional indicia visible from the inside of the vessel, such as a cup. Another aspect is the provision of a light-transmitting vessel which has said indicia disposed on an outer surface so as to be visible by a user viewing the inside of said vessel.

### BACKGROUND

This application relates to systems, methods, and vessels for measuring volumes and manipulating mixtures. This application discloses a measuring vessel which avoids the disadvantages of prior measuring vessels while affording additional operating advantages.

Regular measuring bowls are well suited for certain task, but their use isn't always practical. For example, dispensing coffee is can be quite imprecise, yet a measuring device isn't used by employees, or made available to customers. Furthermore, dispensing inefficiencies are responsible for significant levels of waste, and over time, impact the efficiency of an entire industry.

A particularly good example of dispensing-related waste can be found in every coffee shop. A great deal of coffee is wasted when customers dump coffee in the garbage because a their cup has no additional room for cream.

Coffee production demands a disproportionately large percentage of the world's fresh water supply. By the time it gets brewed, about 40 gallons of fresh water will have been used to produce one cup of coffee. Furthermore, transporting coffee beans to every country on the planet requires an enormous amount of fuel and energy. Despite the coffee industry's thirst for water and other critical resources, little has been done to reduce or eliminate the waste generated from milk and cream lovers who receive too much coffee. Also known as making room for cream, the practice is responsible for wasting millions of gallons of coffee, billions of gallons of water, and an enormous amount of fuel and energy. Unfortunately, the practice of making room for cream has become part of the daily routing for millions of American.

Some coffee retailers address the problem by systematically under-pouring every order, but that leaves customers who do not intend to add milk or cream less than satisfied with their purchase. To avoid leaving many of their customers dissatisfied, some retailers systematically fill every cup; however, this leaves milk and cream lovers with no choice but to dump some of their coffee in the garbage.

It is common practice for retailers to dispense coffee for their customers, but in some cases customers serve themselves. This reduces the need for people to make room for cream, but this retail configuration is quite rare. Furthermore, without a convenient way to add a measured volume of milk or cream and coffee, other additives and flavorings, customers have no way to monitor their consumption of fat, cholesterol, carbohydrates and other nutrients.

While it possible to use a measuring device, such as a measuring cup, it isn't always practical or efficient. For instance, coffee retailers must be able to process each customer's order quickly during peak hours of operation. While a measuring cup can be used to improve consistency, it can be cumbersome for employees to use, share, and clean a measuring cup. Furthermore, it isn't practical for retailers to stock a condiment bar with a measuring cup since it would need to be cleaned after every use.

My invention is particularly useful for adjusting the volume of one fluid, so as to accommodate the volume of a second fluid. My invention can improves retail experience by improving communication between employees and their customers. By improving the accuracy of dispensing coffee retailers can stretch the value of the coffee bean, flavors are more consistent, and the waste associated with customers who make room for cream can be eliminated. Additional benefits include, portion control, nutrient tracking, lower operating costs, improved sanitation, and in some cases, product safety.

In this regard, it must be recognized that measuring vessels are not limited in their utility and application to dispensing coffee. They may also be used for measuring other liquids.

### SUMMARY

A vessel for measuring the volume of content and capable of adjusting the ratio of a mixture of two volumes while maintaining a fixed volume.

A method for adjusting the ratio of two liquids when those liquids combine to equal the volume capacity of a measuring vessel.

A system for improving the efficiency of dispensing liquids.

### BRIEF DESCRIPTION OF THE DRAWINGS

The invention will be more fully understood from the following detailed description taken in conjunction with the accompanying drawings in which:

FIG. 1 is a perspective view of a preferred embodiment of the measuring vessel and bidirectional indicia without geometric distortion.

FIG. 2 is a perspective view of a measuring vessel and bidirectional indicia with geometric distortion.

FIG. 3 is a perspective view of a measuring vessel and oppositely arranged indicia.

FIG. 4 is a perspective view of still another embodiment.

FIG. 5 is a perspective view of a measuring vessel, bidirectional indicia in an inline configuration, 2 units of cream, and coffee with room for two units of cream.

FIG. 6 is a perspective view of the measuring vessel, bidirectional indicia, and inverted indicia.

FIG. 7 is a perspective view of the measuring vessel, bidirectional indicia, and inverted indicia with markings for denoting volume and organizing a customer's preferences.

FIG. 8 is a measuring light-transmissive vessel, bidirectional indicia in an inline configuration, and coffee with room for two units of cream.

### DETAILED DESCRIPTION

While particular preferred and alternative embodiments of the present invention have been disclosed, it will be appreciated that many various modifications and extensions of the above described beverage cup may be implemented using the teaching of this invention. All such modifications and extensions are intended to be included within the true spirit and scope of the appended claims.

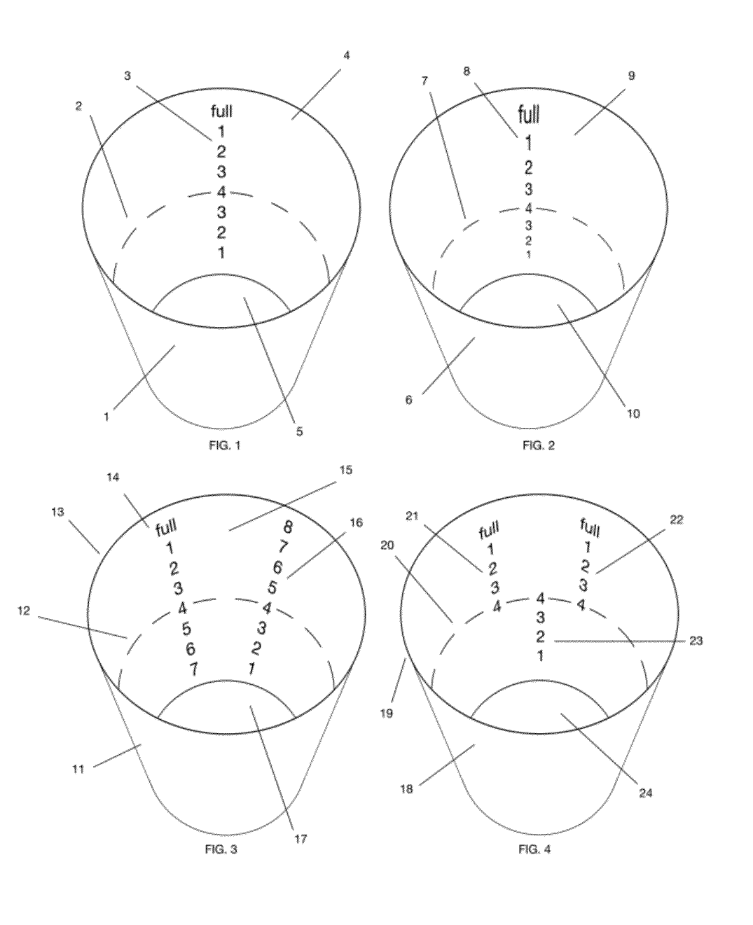

FIG. 1 is a perspective view of a preferred embodiment of the measuring vessel and bidirectional indicia without geometric distortion; wherein a bidirectional volume indicator 3 is positioned on inside wall 4 of a vessel 1 with a base 5. The vessel body 1 is formed from a substantially non-transparent material. Markings 2 are respectively positioned to designate ½ the vessel's 1 volumemetric capacity. Markings 2 also emphase the inflection point of the bidirectional volume indicator 3. In this embodiment, the bidirectional volume indicator 3 is geometrically adjusted to compensate for the optical distortion experienced when viewing the bidirectional volume indicator 3 off-axis.

FIG. 2 is a perspective view of a measuring vessel and bidirectional indicia with geometric distortion; wherein a bidirectional volume indicator 8 is positioned on inside wall 9 of a vessel 6 with a base 10. The vessel body 1 is formed from a substantially non-transparent material. Markings 7 are respectively positioned to designate ½ the vessel's 6 volumemetric capacity. Markings 7 also emphase the inflection point of the bidirectional volume indicator 3. In this embodiment, the bidirectional volume indicator 8 is NOT geometrically adjusted to compensate for the optical distortion.

FIG. 3 is a perspective view of a measuring vessel and oppositely arranged indicia; wherein a bidirectional volume indicator comprises two indicia 14 16, each measures the full volume range of the vessel 11, and are oriented in opposite directions. The standard indicator indicia 16 measures up from the base 17 and are positioned on inside wall 15. The vessel body 11 is formed from a substantially non-transparent material. Markings 12 are respectively positioned to designate ½ the vessel's 11 volumemetric capacity. Markings 12 also intersects both volume indicators. In this embodiment, the bidirectional volume indicator 8 and 14 are geometrically adjusted to compensate for the optical distortion.

FIG. 4 is a perspective view of still another embodiment; wherein a bidirectional volume indicator is arranged in a generally Y-shaped 23 pattern. The standard indicator indicia 16 measures up from the base 17 and are positioned on inside wall 15. The vessel body 11 is formed from a substantially non-transparent material. Markings 12 are respectively positioned to designate ½ the vessel's 11 volumemetric capacity. Markings 12 also intersects both volume indicators. In this embodiment, the bidirectional volume indicator 8 and 14 are geometrically adjusted to compensate for the optical distortion.

FIG. 5 is a perspective view of a measuring vessel, bidirectional indicia in an inline configuration, with 2 units of cream 29 or coffee 27 with enough room for 2 units of cream, and indicated by the bidirectional volume indicator 28. The vessel body 25 is formed from a substantially non-transparent material. Markings 26 are respectively positioned to designate ½ the vessel's 25 volumemetric capacity. Markings 26 also emphase the inflection point of the bidirectional volume indicator 28. In this embodiment, the bidirectional volume indicator 28 is geometrically adjusted to compensate for the optical distortion experienced when viewing the bidirectional volume indicator 28 off-axis.

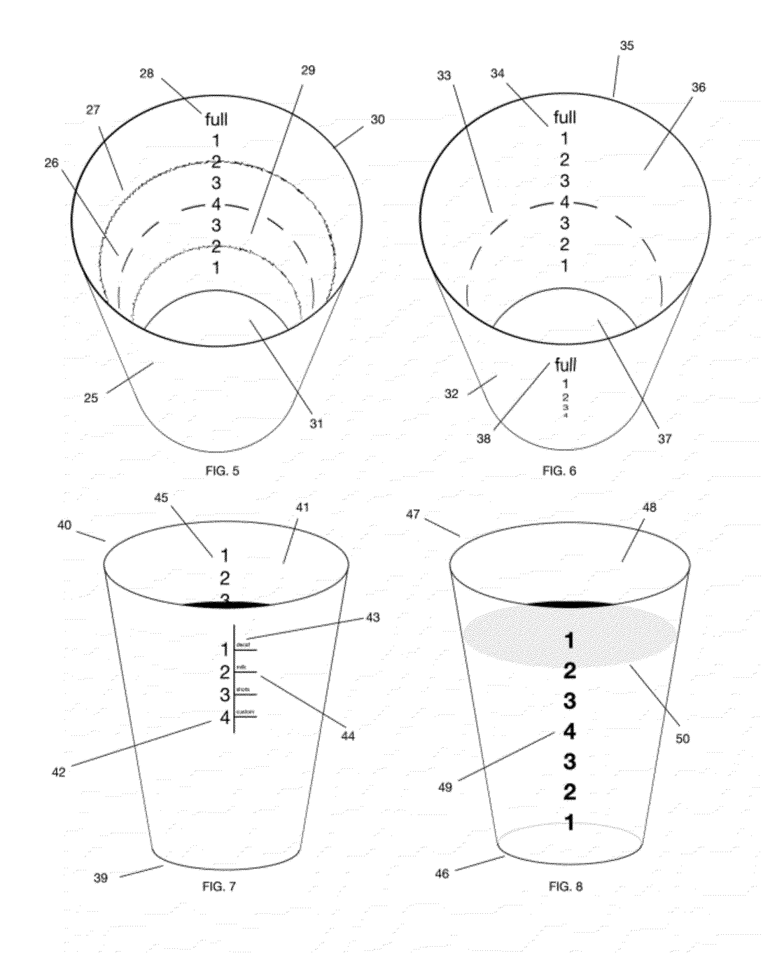

FIG. 6 is a perspective view of the measuring vessel, bidirectional indicia, and inverted indicia deposed on the outside of the vessel 32, wherein a bidirectional volume indicator 34 is positioned on inside wall 36. Markings 33 are respectively positioned to designate ½ the vessel's 32 volumemetric capacity. Markings 33 also emphase the inflection point of the bidirectional volume indicator 3. In this embodiment, the bidirectional volume indicator 34 is geometrically adjusted to compensate for the optical distortion experienced when viewing the bidirectional volume indicator 3 off-axis.

FIG. 7 is a perspective view of the measuring vessel, bidirectional indicia, and inverted indicia with markings for denoting volume and organizing a customer's preferences 42 deposed on the outside of the vessel 40, wherein a bidirectional volume indicator 45 is positioned on inside wall 41. Markings 44 vertically spaced, respectively designate different volumes, and organize information 43 about a customer's preferences, so as to eliminate the need for additional markings.

FIG. 8 is perspective view of a light-transmissive vessel and bidirectional indicia in an inline configuration, and coffee with room for 2 ounces of cream 49. The vessel body 47 is formed from a light-transmissive material.

What is claimed:

1. A vessel, comprising:
one or more side walls, an optional top, and an optional bottom, is formed from a substantially non-transparent material wherein at least one or more sidewalls has indicia inscribed thereon,
defining a cavity with an open upper end for receiving contents having a measurable volume,
indicia disposed on the inside surface of the side wall portion, and
providing a readily observable indication of the volume contents in the vessel,

2. The vessel of claim 1, wherein the indicia, including vertically spaced markings, respectively designating different volumes,

3. The vessel of claim 1, the indicia being respectively distorted such that when viewed off axis, the indicia and markings will appear less distorted.

4. The vessel of claim 1, wherein the vessel has at least two indicia.

5. The vessel of claim 4, wherein at least one indicia is oriented in an opposite direction with respect to another indicia.

6. The vessel of claim 5, wherein the indicia do not go beyond half the vessel's volume.

7. The vessel of claim 6, wherein the indicia are arranged inline with respect to the other indicia.

8. The vessel of claim 1, wherein the wall structure is transparent.

9. The vessel of claim 8, wherein the indicia in at least one of the sets include reversed alphanumeric characters.

10. The vessel of claim 1, wherein the the indicia include plural sets sets of indicia.

11. The vessel of claim 1, wherein the side wall portion is substantially frustoconical in shape.

12. The vessel of claim 6, wherein the indicia including indicia arranged in a generally Y-shaped pattern.

13. The vessel of claim 1, wherein the indicia are inscribed on the outside of the vessel.

14. The vessel of claim 13, wherein the indicia are inscribed on the outside of the vessel.

15. The vessel of claim 5, wherein at least one indicia is inscribed on the outside of the vessel.

16. The vessel of claim 15, wherein at least one indicia measures down from the top of the measuring cavity.

17. The vessel of claim 15, wherein the indicia stops half way down the vessel's measuring cavity.

18. The vessel of claim 16, wherein vertically spaced markings, respectively designate different volumes, and organize information about a customer's preferences, so as to eliminate the need for additional markings

19. A method for using a the vessel in claims 1-18 to precisely adjust the fill line for a volume of content, so as to accommodate a second volume of content.

20. A system for using the method in claim 19 and the vessel in claims 1-18 to dispense beverages, wherein the first beverage can be dispensed to precisely accommodate the volume of a second beverage, and to use said vessels for measuring the volume of the first or second beverage.
